(19) United States
(12) Patent Application Publication
(10) Pub. No.: US 2012/0039446 A1
(43) Pub. Date: Feb. 16, 2012

(54) INTERWOVEN MULTI-APERTURE COLLIMATOR FOR 3-DIMENSIONAL RADIATION IMAGING APPLICATIONS

(75) Inventors: Yonggang Cui, Miller Place, NY (US); Ralph B. James, Ridge, NY (US)

(73) Assignee: Brookhaven Science Associates, LLC, Upton, NY (US)

(21) Appl. No.: 13/262,811

(22) PCT Filed: Mar. 31, 2010
(86) PCT No.: PCT/US10/29409

§ 371 Date: Oct. 26, 2011

Related U.S. Application Data
(60) Provisional application No. 61/165,653, filed on Apr. 1, 2009.

(51) Int. Cl. G21K 1/02

(52) U.S. Cl. 378/149

(57) ABSTRACT

An interwoven multi-aperture collimator for three-dimension radiation imaging applications is disclosed. The collimator comprises a collimator body including a plurality of apertures disposed in a two-dimensional grid. The collimator body is configured to absorb and collimate radiation beams emitted from a radiation source within a field of view of said collimator. The collimator body has a surface plane disposed closest to the radiation source. The two-dimensional grid is selectively divided into at least a first and a second group of apertures, respectively defining at least a first view and a second view of an object to be imaged. The first group of apertures is formed by interleaving or alternating rows of the grid, and the second group of apertures is formed by the rows of apertures adjacent to the rows of the first group. Each aperture in the first group is arranged in a first orientation angle with respect to the surface plane of said collimator body, and each aperture in the second group is arranged in a second orientation angle with respect to the surface plane of said collimator body such that the apertures of the first group are interwoven with the apertures of the second group.

### CROSS-REFERENCE TO A RELATED APPLICATION

This application claims the benefit under 35 U.S.C. 119(e) of U.S. Provisional Application No. 61/165,653 filed on Apr. 1, 2009, the content of which is incorporated herein in its entirety.

### STATEMENT OF GOVERNMENT LICENSE RIGHTS

The present invention was made with government support under contract number DE-ACO2-98CH10886 awarded by the U.S. Department of Energy. The United States government may have certain rights in this invention.

### BACKGROUND

I. Field of the Invention

This invention relates to the field of radiation imaging. In particular, this invention relates to an interwoven multi-aperture collimator for 3-dimensional radiation imaging applications.

II. Background of the Related Art

Improvements in X-ray and gamma-ray detectors have revolutionized the potential of radiation imaging applications. Radiation imaging applications may range anywhere from astronomy to national security and nuclear medicine applications, among others. Gamma cameras, for example, have been widely used for nuclear medical imaging to diagnose disease by localizing abnormal tissue (e.g., cancerous tissue) inside the human body.

Generally, nuclear medical imaging uses radiation emitters in the 20-1500 keV range because at these energies most of the emitted rays are sufficiently penetrating to transmit through a patient even if the radiation is generated deep within the patient's body. One or more detectors are used to detect the emitted radiation from a specific part of the imaged object, and the information collected from the detector(s) is processed to calculate the position of origin of the emitted radiation within the body organ or tissue under study. Radioactive tracers, generally used in nuclear medical imaging, emit radiation in all directions. Because it currently is not possible to focus radiation at very short wavelengths through the use of conventional optical elements, collimators are used in nuclear medical imaging. A collimator is a radiation absorbing device that is placed in front of a scintillation crystal or solid state detector to allow only radiation aligned with specifically designed apertures to pass through to the detector. In this manner a collimator guides radiation from a specific part of the imaged object onto a specific area of a detector. In most applications, the choice of collimator represents a trade-off between sensitivity (the amount of radiation recorded), the resolution (how well the trajectory of a particular ray of radiation from the object to the detector is resolved) and the size of the field-of-view (the maximum size of the object to be imaged).

FIG. 1A illustrates an example of a conventional radiation imaging system 100. Radiation imaging system 100 includes a radiation detection device 40 coupled via a communication network 50 to a signal processing unit 60 and then to an image analysis and display unit 70. Radiation detection device 40 includes the collimator 42 and a detector module 45. Collimator 42 is fabricated of a radiation absorbing material (usually lead, but may include other absorbing materials such as tungsten or gold), and includes a plurality of closely arranged apertures A, e.g., parallel holes or pinholes. Detector module 45 is arranged parallel to collimator 42, and includes a plurality of radiation detector elements 44. Radiation detector elements 44 are arranged in a one- or two-dimensional array atop a mounting frame board 46. The axes of apertures A in the collimator 42 are perpendicular to the surface plane of the radiation detector module 45, and often designed and positioned such that each one of the apertures A is aligned in correspondence with each radiation detector element 44. In some cases, the apertures may not be precisely aligned with each detector element. For example, there may be multiple apertures aligned perpendicularly to a single detector element, or a single aperture may be aligned perpendicularly with multiple detector elements. In other cases, there may be a honeycomb-like collection of collimators positioned perpendicularly to, but in a manner that they do not precisely match, the arrangement of the detector elements. In each of the above-mentioned cases, a perpendicular orientation of the apertures with respect to the detector elements is selected to advantageously maximize the field-of-view of a radiation detection device.

In the conventional imaging system of FIG. 1A, imaging system 100 allows for an object 20 placed at a predetermined distance p from the radiation detection device to be imaged. In some arrangements, object 20 may be placed at a position between a radiation source (not shown) and the radiation detection device 40. A radioactive isotope chemically included in a tracer molecule is administered to a subject of interest (object 20). The radioactive isotope concentrated in a target area 10, e.g., damaged tissue, decays and emits radiation beams 30 with a characteristic energy. The emitted radiation beams 30 traverse the object 20 and, if not absorbed or scattered by body tissue, for example, the beams 30 exit the object 20 along a straight-line trajectory. Collimator 42 blocks/absorbs radiation beams that are not parallel to the axes of apertures A. Radiation beams 30 parallel to aperture A are detected by the radiation detector elements 44 of radiation detection module 45. The radiation detected at detector module 45 is transmitted to the signal processing unit 60 via communication network 50 in a known manner. Signal processing unit 60 processes the information corresponding to the detected radiation and sends it digitally to the image analysis and display unit 70. The resultant image taken with imaging system 100 is a projection of object 20 onto the surface plane of detector module 45. The main drawback of this conventional system is that only a single two-dimensional (2-D) projection of the radiation within the imaged object can be obtained at any given time.

Several techniques have been developed to overcome this drawback. A first known approach used in commercial imaging applications, such as computerized tomography (CT), single photon emission computed tomography (SPECT), position emitted tomography (PET), and scintimammography, relies on the use of a plurality of detector modules strategically placed around the object of interest, or the use of a single detector module orbiting around the object of interest.

FIG. 1B illustrates a conventional CT system including a radiation source 15 in correspondence with a single radiation detection device 40 orbiting around an object of interest 20. In this case, radiation detection device 40 includes, for example, a parallel-hole collimator 42 and a detector module 45. Radiation detection device 40 records a first 2-D image of object 20 while the detector is motionless in a first position (Position 1). Then, the radiation detection device 40 in correspondence with radiation source 15 rotates by a few degrees to successive positions and records a series of corresponding successive 2-D images. Depending on the type of imaging application, the arrangement of FIG. 1B would require any number of n positions and corresponding n number of 2-D images necessary for accurate imaging.

FIG. 1C illustrates a conventional PET system where a plurality of radiation detection devices 40a through 40f are arranged around an object 20, e.g., a human body, including a radioisotope tracer 10, so as to obtain a plurality of corresponding a through f 2-D images from different angles. Radiation detection devices 40a through 40f may be configured in a manner similar to the examples of FIGS. 1A and 1B, so that each radiation detection device includes, for example, a parallel-hole collimator 42 and corresponding detector module 45. In the arrangement of FIG. 1C, the number of radiation detectors and corresponding 2-D images captured would also be determined by type of imaging application required.

In either of the above-described cases, the data obtained from a large set of 2-D images can be used to reconstruct a three-dimensional (3-D) image tomographically. However, both of these approaches result in bulky and processing-intensive systems that can only be used for external diagnosis of the body. These systems cannot be used very close to the human body, or internally to human organs, e.g., in a trans-rectal probe for detecting prostate cancer, or in mammography for breast cancer, since it is not possible to rotate around the prostate or to position an array of detectors around the prostate when viewing the gland using a trans-rectal probe.

Another approach is to use a non-uniform collimator. FIG. 1D illustrates one possible configuration of radiation imaging devices using a non-uniform collimator, such as those disclosed in U.S. Pat. Nos. 4,659,935, 4,859,852, and 6,424,693. FIG. 1D illustrates a radiation detector 40 configured to obtain a plurality of different but simultaneous 2-D images of object 20. The different 2-D images are produced by groups of apertures H designed to simultaneously guide radiation beams 30 to two or more sections of radiation detection device 40. Thus, the basic idea in this type of device is to divide a collimator into two or more sections, and give the apertures H in each section of the collimator different slant angles with respect to the surface plane of the collimator. As illustrated in FIG. 1D, apertures H on section 42A of the collimator may have a slant angle towards the right, while apertures H in section 42B may have a slant angle towards the left with respect to the collimator's surface plane. With a collimator such as that illustrated in FIG. 1D, the two or more simultaneous images of different views of a given object are obtained by using a single radiation detector 40 and without having to move the detector.

When used on the human body, however, the non-uniform collimator approach presents at least two drawbacks. A first issue is that the radiation detection device 40 cannot be used very close to the object being imaged because the field-of-view (FOV), as illustrated by the shaded area on FIG. 1D, becomes increasingly smaller as the detection device 40 approaches the object. The time required to obtain a complete image of the object increases considerably as the object is positioned further away from the radiation detector. A second issue is that in order to take an image of the entire object at one time, i.e., in a single shot, the size of detector's surface plane must be at least twice the size of the object to be imaged. Thus, the overall size of the radiation detection device becomes larger. As a result, the non-uniform collimator approach is impractical for imaging applications where operational space is limited and the size of the radiation detection device is required to be small, e.g., viewing of the object through a body cavity such as rectal, vaginal or esophageal.

In view of the foregoing challenges encountered in the conventional radiation imaging systems, it is highly desirable to develop a new collimator and collimation technique that would enable fast 3-D radiation imaging while maintaining an object of interest at the closest possible distance from a small-sized detector.

### SUMMARY

In accordance with the present invention, an interwoven multi-aperture collimator for 3-dimensional radiation imaging applications is disclosed. The collimator comprises a collimator body configured to absorb and collimate radiation beams emitted from a radiation source within a field-of-view of the collimator. The collimator body has a surface plane disposed closest to the radiation source. A plurality of apertures is disposed in a two-dimensional grid throughout the surface plane of the collimator body. The plurality of apertures is divided into groups such that each group of apertures defines respective views of an object to be imaged. A first group of apertures is formed by interleaving or alternating rows of the grid; a second group of apertures is formed by the rows of apertures adjacent to the rows of the first group. The apertures of the first group have respective longitudinal axes aligned along a first orientation angle with respect to the surface plane; and the apertures of the second group have respective longitudinal axes aligned along a second orientation angle with respect to the surface plane such that the apertures of the first group are interwoven with the apertures of the second group.

In addition, the plurality of apertures may be further divided into a third group. The third group of apertures defines respectively a third view of an object to be imaged. The third group of apertures is formed by further interleaving or alternating rows of the grid located between the rows of apertures of the first and second groups. The apertures within the third group have longitudinal axes aligned along a third orientation angle with respect to the surface plane such that the apertures of the third group are interwoven with the apertures of the first and second groups.

In addition, the plurality of apertures may be further divided into a fourth, fifth, sixth, seventh, eighth, ninth and so on and so forth group. Each additional group of apertures defines respectively an additional view of an object to be imaged. Each additional group of apertures is formed by further interleaving or alternating rows of the grid located between the rows of apertures of the earlier groups, e.g., for forth group, it would be first, second, and third groups. The apertures within this additional group have longitudinal axes aligned along a further desirable orientation angle with respect to the surface plane such that the apertures of these groups are interwoven with the apertures of the earlier groups, e.g., first, second, and third groups.

Preferably, in the multi-aperture collimator, the apertures in the first group are orthogonal to the surface plane of the collimator body, while the apertures of the second group are slanted to a predetermined angle with respect to the surface plane of the collimator body. Alternatively, the apertures in the first group may be slanted to a first direction with respect to the surface plane, while the apertures of the second group may be slanted to a second direction with respect to the surface plane. When the plurality of apertures is divided into three groups, the apertures of the first group are slanted to a first predetermined angle with respect to the surface plane, the apertures of the second group are slanted to a second predetermined angle with respect to the surface plane, and the apertures of the third group are perpendicular to the surface plane of said collimator body.

The plurality of apertures may preferably be pinholes or parallel holes. The plurality of apertures may be formed by directly machining holes in a solid plate of radiation-absorbing material, laterally arranging septa of radiation-absorbing material so as to form predetermined patterns of radiation guiding conduits or channels, or vertically stacking multiple layers of radiation-absorbing material with each layer having predetermined aperture cross-sections and/or aperture distribution patterns. The plurality of apertures may have a geometric cross-section defined by at least one of a circle, a parallelogram, a hexagon, a polygon, or combinations thereof.

The plurality of apertures disposed in the two-dimensional grid may be arranged such that rows of the grid are perpendicular to columns of the grid, or the rows of the grid may be offset from each other so as to form a honeycomb-like structure.

The present invention also discloses a radiation imaging device configured to perform three-dimensional radiation imaging. The radiation imaging device comprises an interwoven multi-aperture collimator as described above, and a radiation detection module designed in accordance with a pixilated detector design, an orthogonal strip design, or a mosaic array arrangement of single individual detectors.

The interwoven multi-aperture collimator of the present invention addresses imaging applications where a compact radiation detector is required and an object of interest can be positioned close to, or even in contact with, a radiation detection device's surface plane. For example, the object may be positioned within zero to a few inches from the collimator's surface plane. Other unique aspects of the interwoven multi-aperture collimator of this invention are that it allows for the design of compact radiation detection devices, e.g., gamma cameras, of sizes comparable to the size of the object of interest, and enables swift and efficient imaging with superior sensitivity and spatial resolution.

One example of an application where such a compact design may be desirable is the construction of radiation detection probes for prostate cancer detection. When used in prostate gland imaging, the compact size of the radiation detection device and the ability to use it very closely to the object of interest are particularly desirable not only for the patients' comfort, but also for more accurately pinpointing of damaged or unhealthy tissue. In addition, positioning the detection device within zero to a few inches from the object of interest can advantageously produce high-quality images, and the greater sensitivity results in shorter image collection times and less radioactive tracer injected into patients, as compared to radiation detection devices that are used external to the patient's body.

In accordance with the present invention, a method of radiation imaging in a patient is disclosed. The method comprises the steps of (a) defining a predetermined target location in an object of interest, (b) positioning an interwoven multi-aperture collimator of the present invention near the target location, (c) collimating the radiation emitted from the radiation source by an interwoven multi-aperture collimator in the field of view of said interwoven multi-aperture collimator into at least two views of the target location, where, the view of the target location is defined by a plurality of apertures disposed in a two-dimensional grid throughout a collimator body, (d) detecting the radiation that passes through the interwoven multi-aperture collimator by a radiation detection module, and (e) processing the information recorded by the radiation detection module to produce a desired image based on the defined angle of the apertures in the interwoven multi-aperture collimator. In another embodiment of the present invention, the method of radiation imaging comprises collimating radiation from the target location by an interwoven multi-aperture collimator in the field of view of said interwoven multi-aperture collimator into a first and a second view of the target location. The first and second views of the target location are defined, respectively, by a first group and a second group of apertures disposed throughout the collimator body. The first group of apertures is formed by interleaving the rows of apertures, and the second group of apertures is formed by rows of apertures adjacent to the rows of the first group. The apertures within the first group have respective longitudinal axes aligned along a first orientation angle with respect to the surface plane. Whereas, the apertures within the second group have respective longitudinal axes aligned along a second orientation angle with respect to the surface plane such that the apertures of the first group are interwoven with the apertures of the second group. In yet another embodiment of the present invention, the method of radiation imaging further comprises collimating the radiation emitted from the radiation source by the interwoven multi-aperture collimator into a third view of the target location. In still another embodiment of the present invention, the method of radiation imaging further comprises collimating the radiation emitted from the radiation source by the interwoven multi-aperture collimator into a fourth, a fifth, a sixth and so on view of the target location.

### BRIEF DESCRIPTION OF THE DRAWINGS

FIG. 1A illustrates a conventional prior art radiation imaging system for explaining the imaging principle thereof.

FIG. 1B illustrates a configuration of a conventional prior art CT system in which a radiation detection device in correspondence with a radiation source rotates around the imaged object.

FIG. 1C illustrates a conventional prior art PET system where multiple radiation detection devices are arranged around the object.

FIG. 1D illustrates a configuration of a conventional prior art non-uniform collimator.

FIG. 2 illustrates one embodiment of an interwoven multi-aperture collimator including two groups of apertures with cross sectional views along the center of adjacent rows of apertures, in accordance with the present invention.

FIGS. 3A and 3B illustrate exemplary distributions of apertures on the surface of the interwoven multi-aperture collimator.

FIGS. 4A and 4B illustrate exemplary field-of-view arrangements in two different embodiments of an interwoven multi-aperture collimator with two groups of apertures interwoven with each other.

FIGS. 5A, 5B and 6 illustrate further embodiments of the interwoven multi-aperture collimator.

FIG. 7 illustrates an exemplary embodiment of a radiation imaging device using an interwoven multi-aperture collimator with an orthogonal strip detector.

FIG. 8 illustrates an exemplary embodiment of a radiation imaging device using an interwoven multi-aperture collimator with an array of single detector elements.

FIG. 9 illustrates an exemplary embodiment of a radiation imaging device using and interwoven multi-aperture collimator with a pixilated detector.

### DETAILED DESCRIPTION

In the interest of clarity in describing the embodiments of present invention, the following terms and acronyms are defined as set forth below.

### DEFINITIONS

2-D: two-dimensional: generally directed to 2-D imaging,
3-D: three-dimensional: generally directed to 3-D imaging,
aperture: generally refers to a conduit or channel fabricated or constructed in the body of a collimator for guiding radiation from an object of interest to a detecting element. Thus, “aperture” may also be referred to as a pinhole, parallel hole, a radiation guide, or the like.
CT: computed tomography,
FOV: field of view
keV: kilo-electron volt (a unit of energy equal to one thousand electron volts),
object: refers to an article, organ, body part or the like either in the singular or plural sense,
PET: positron emission tomography,
septa: thin walls or partitions forming conduits or channels for guiding radiation,
SPECT: single photon emission computed tomography.

In the following description of the various examples, reference is made to the accompanying drawings where like reference numerals refer to like parts. The drawings illustrate various embodiments in which an interwoven multi-aperture collimator for 3-D radiation imaging applications may be practiced. It is to be understood, however, that those skilled in the art may develop other structural and functional modifications without departing from the scope of the instant disclosure.

### I. Structure of an Interwoven Multi-Aperture Collimator

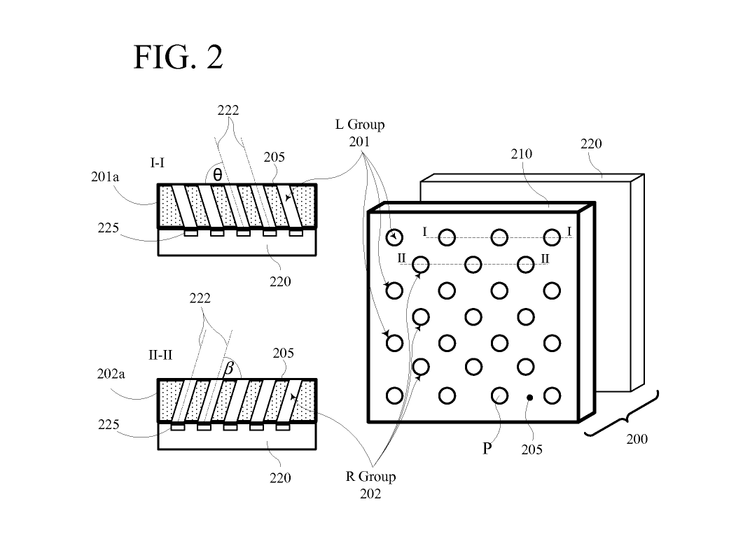

FIG. 2 illustrates one exemplary embodiment, in accordance with the present invention, of an interwoven multi-aperture collimator with cross-sectional views through the centers of adjacent rows of apertures. Referring to FIG. 2, radiation detection device 200 includes a multi-aperture collimator 210 and a detector module 220. Multi-aperture collimator 210 comprises a radiation-absorbing collimator body having a surface plane 205 disposed closest to a radiation source (not shown) and includes a plurality of apertures P arranged throughout the collimator body.

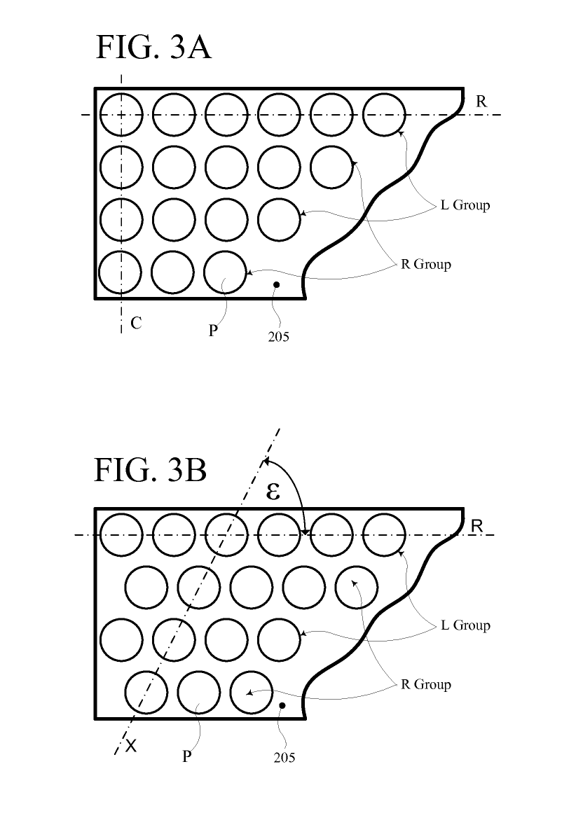

FIG. 3A illustrates one possible arrangement in which the plurality of apertures P are arranged on the surface plane 205 of the collimator body in an orthogonal two-dimensional grid of rows and columns In an orthogonal two-dimensional grid arrangement, the apertures in the collimator are organized in rows and columns, which are aligned with each other such that an imaginary line R traveling across the center of a row of apertures would be perpendicular to an imaginary line C traveling across the center of a column of apertures. In other words, rows and columns are orthogonal to each other. Alternatively, as shown in FIG. 3B, the plurality of apertures may be arranged in a succession of rows adjacent to each other, but each row is offset from the adjacent one by a predetermined angle ε, so as to form honeycomb-like structure. In a honeycomb-like structure, since the rows are offset from each other, no orthogonal columns of apertures would be formed. Accordingly, in an offset arrangement, an imaginary line R traveling across the center of a row of apertures would form an angle ε with an imaginary line X traveling transversely through the center of a corresponding aperture in an adjacent row. In either case, the plurality of apertures is selectively divided into at least two groups (L Group and R Group).

Referring again to FIG. 2, a first group of apertures 201 (L Group) is formed by alternating (interleaving) rows of apertures in the grid. A cross-sectional view I-I across the center of a row of apertures of the first group is illustrated on the top-left side of FIG. 2, as designated by reference numeral 201a. In this first group, the apertures have longitudinal axis 222 that are arranged in a first orientation angle θ (e.g., slanted to the left in FIG. 2) with respect to the collimator's surface plane 205.

Similarly, a second group of apertures 202 (R Group) is formed by alternating (interleaving) the rows of apertures adjacent to those of the first group. A cross-sectional view II-II across the center of a row of apertures of the second group is illustrated on the bottom-left side of FIG. 2, as designated by reference numeral 202a. In the second group, the apertures have respective longitudinal axis 222 that are arranged in a second orientation angle β (e.g., slanted to the right in FIG. 2) with respect to the collimator's surface plane 205. The angle β may or may not be equal to the angle θ depending on the requirements of a specific application.

As a result of the above-described arrangement, the rows of apertures from these two groups are interwoven with each other. Specifically, all of the apertures in the rows of the first group 201 are arranged in a first orientation angle θ, while all of the apertures in the rows of the second group are arranged in a second orientation angle β, and the rows of the first group and the rows of the second group are alternatingly interleaved with each other. Within the first group 201 and the second group 202 all of the apertures P are parallel. More specifically, within each group, each of the axes 222 of the plurality of apertures P is parallel to all others.

In a preferred embodiment, the collimator body having a surface plane 205 of collimator 210 may be fabricated from a radiation-absorbing material known as the “high-Z” materials that have high density and moderate-to-high atomic mass. The examples of such materials include, but not limited to, lead (Pb), tungsten (W), gold (Au), molybdenum (Mo), and copper (Cu). The selection of the radiation-absorbing material and the thickness of the radiation-absorbent material should be determined so as to provide efficient absorption of the incident radiation, and would normally depend on the type of incident radiation and the energy level of the radiation when it strikes the surface plane of the collimator. The type of incident radiation and the energy level of the radiation depends on the particular imaging application, e.g., medical or industrial, or may be designed to be used in any of several different applications by using a general purpose radiation-absorbing material. In one embodiment, applicable to industrial and/or medical applications, the incident radiation is emitted by an external radiation source or device that generates X-rays. In medical application, for instance, in one embodiment, Indium-111 (¹¹¹In; 171 keV and 245 keV) and Technetium-99m (^{99m}Tc; 140 keV) are used as a radioactive tracer for imaging of prostate or brain cancer. In such applications, it is envisioned that the collimator 210 may be fabricated from tungsten, lead, or gold. In another embodiment as applicable to medical applications, Iodine-131 (¹³¹I; 364 keV) is used as a radioactive tracer for imaging and/or as a radioactive implant seed for treatment of thyroid cancer. In such applications, it is envisioned that the collimator 210 may be fabricated from tungsten, lead, or gold. In yet another embodiment as applicable to medical applications, Iodine-125 (¹²⁵I; 27-36 keV) and Palladium-103 (¹⁰³Pd; 21 keV) are used as a radioactive implant seed for treatment of the early stage prostate cancer, brain cancer, and various melanomas. In such applications, it is envisioned that the collimator 210 may be fabricated from copper, molybdenum, tungsten, lead, or gold. In one preferred embodiment, the collimator 210 is fabricated from copper. In another preferred embodiment, the collimator 210 is fabricated from tungsten. In yet another preferred embodiment, the collimator 210 is fabricated from gold. The collimator body defining the surface plane 205 may be fabricated of a solid layer of radiation-absorbing material of a predetermined thickness, in which the plurality of apertures may be machined in any known manner according to optimized specifications. For example, a solid layer of radiation-absorbing material of a predetermined thickness may be machined in a known manner, e.g., using precision lasers, a collimator with the appropriate aperture parameters and aperture distribution pattern may be readily achieved.

The collimator body containing the plurality of apertures may also be fabricated by laterally arranging septa of radiation-absorbing material so as to form predetermined patterns of radiation-guiding conduits or channels. In addition, the collimator body having a plurality of apertures may be manufactured by vertically stacking multiple layers of radiation-absorbing material with each layer having predetermined aperture cross-sections and distribution patterns so as to collectively form radiation-guiding conduits or channels. For example, multiple layers of lead, gold, tungsten, or the like may be vertically stacked to provide enhanced absorption of stray and scattered radiation to thereby ensure that only radiation with predetermined wavelengths is detected. In the case of vertically stacking multiple layers, the collimator may be formed by stacking repetitive layers of the same radiation-absorbing material, or by stacking layers of different radiation-absorbing materials.

In the interwoven multi-aperture collimator 210, the aperture parameters such as aperture diameter and shape, aperture material, aperture arrangement, number of apertures, focal length, and acceptance angle(s) are not limited to specific values, but are to be determined subject to optimization based on required system performance specifications for the particular system being designed, as will be understood by those skilled in the art. Extensive patent and non-patent literature providing optimal configurations for apertures such as pinholes and parallel holes is readily available. Examples of such documentation are U.S. Pat. No. 5,245,191 to Barber et al., entitled Semiconductor Sensor for Gamma-Ray Tomographic Imaging System, and non-patent literature article entitled “Investigation of Spatial Resolution and Efficiency Using Pinholes with Small Pinhole Angle,” by M. B. Williams, A. V. Stolin and B. K. Kundu, IEEE TNS/MIC 2002, each of which is incorporated herein by reference in its entirety.

Referring back to FIG. 2, in order to reduce the overall size of a radiation detection device, collimator 210 is adapted to be positioned substantially parallel to detector module 220 such that collimator 210 may be preferably positioned close to, or even in contact with, detector module 220. Detector module 220 is arranged with respect to collimator 210 so as to align each axis 222 of aperture P with the center of a corresponding detector element 225, as illustrated in the cross-sectional views I-I and II-II of FIG. 2. In this manner, the detector module 220 including a two-dimensional array of detector elements 225 is also virtually divided into two groups. As a result, the rows of the two groups of detector elements 225 are also interleaved in a manner similar to the rows of the collimator 210.

The interwoven multi-aperture collimator illustrated in FIG. 2 provides several features distinguishing it from those conventionally known heretofore. For example, this collimator allows for the simultaneous imaging of an object from at least two different views, while maintaining the object of interest very close to, or even in contact with, the radiation detection device 200. Thus, the overall size of the radiation detection device, e.g., gamma ray camera, can be effectively reduced. The specific arrangement of this interwoven multi-aperture collimator is considered particularly significant to radiation imaging applications where the radiation detecting device is required to be positioned close to the object of interest and the size of the detector is required to be small. Moreover, when the apertures in the interwoven multi-aperture collimator of the present invention are designed in the form of pinholes, an interwoven multi-pinhole collimator offers increased sensitivity without sacrificing spatial resolution. Specifically, an interwoven multi-aperture collimator as disclosed herein allows for the imaging of large FOVs with relatively small but high-resolution radiation detectors.

The above-described embodiment of FIG. 2 of the present invention is directed, among other things, to balancing the tradeoff between efficiency and spatial resolution by reducing the distance between the object and the radiation detection device, so that a radiation detection device may be positioned close to, or even in contact with, the object of interest.

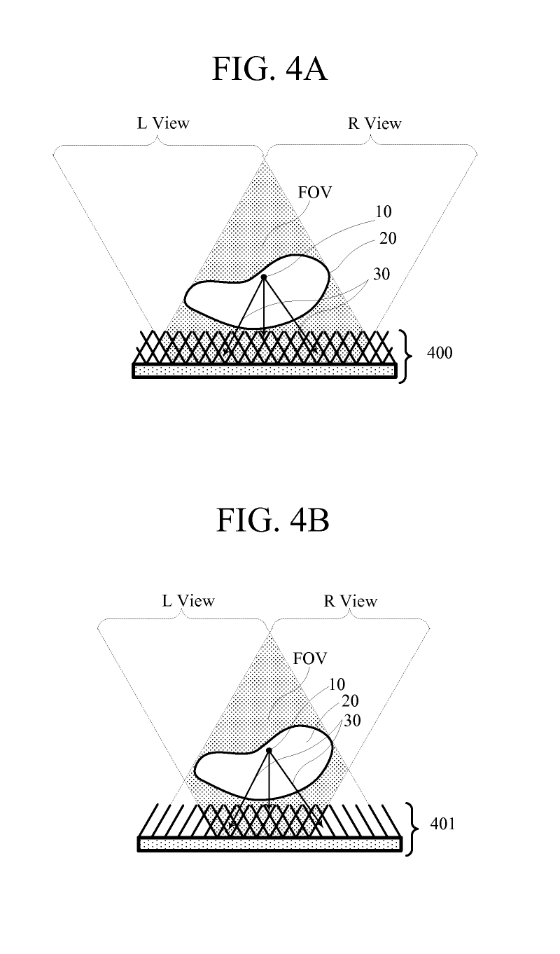

FIGS. 4A and 4B illustrate the collimation process and advantages thereof obtained with different embodiments of the interwoven multi-aperture collimator of the present invention. The interweaving of the groups of apertures A may be complete or partial depending upon the desired application. “Complete” interweaving means that all of the holes in one group of apertures sit in the area covered by the other group of apertures, except perhaps for the apertures on the edges of the collimator body. If some (not all) of the apertures in one group sit beyond the area covered by another group, the apertures is “partially” interwoven.

FIG. 4A illustrates a radiation detection device 400 including an interwoven multi-aperture collimator in which two groups of apertures are completely interwoven. As can be appreciated from FIG. 4A, by “completely” interweaving a first group of apertures arranged along a first orientation angle with a second group of apertures disposed along a second orientation angle, two different fields of view are defined, L VIEW by a first group of apertures and R VIEW by a second group of apertures. Because of the complete interwoven arrangement of the aperture groups, two fields of view are overlapped with each other at the surface of the collimator. Thus, a relatively wide FOV is readily achieved near the collimator, allowing the detection device 400 to be positioned very close to the object of interest and to image the entire object 20 simultaneously from at least two different orientation angles. This arrangement dramatically increases the sensitivity and the efficiency of radiation detection device 400.

FIG. 4B illustrates a radiation detection device 401 in which the interwoven multi-aperture collimator is designed so that only part of the apertures are interwoven. In the embodiment of FIG. 4B, even if the two groups of apertures are only partially interwoven, radiation detection device 401 placed at a distance substantially close to an object 20 allows for imaging the entire object with optimal imaging sensitivity and resolution. In the arrangement as illustrated in FIG. 4B, since the two groups of the apertures are only partially interwoven with each other, the FOV is effectively extended along the direction perpendicular to the detector module. Thus, in comparison with the “completely” interwoven configuration of FIG. 4A, this configuration allows imaging objects that are located further away from the detector device while still maintaining enhanced sensitivity and efficiency in the radiation detection device. In addition, by only partially interweaving the two groups of apertures, different degrees of imaging resolution can be obtained. For example, the section of the radiation detection device 401 where the two groups of apertures are interwoven (i.e., where the FOV of the first group overlaps the FOV of the second group) would provide higher imaging resolution than the sections where the two groups of apertures are not interwoven. Thus, selective imaging resolution may be achieved.

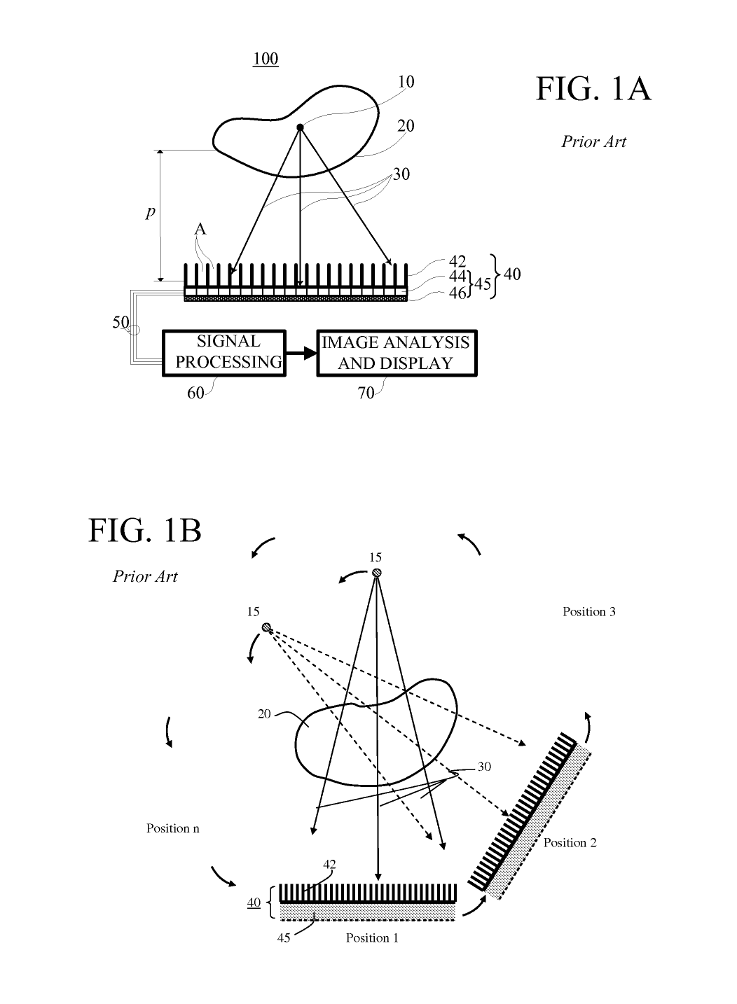

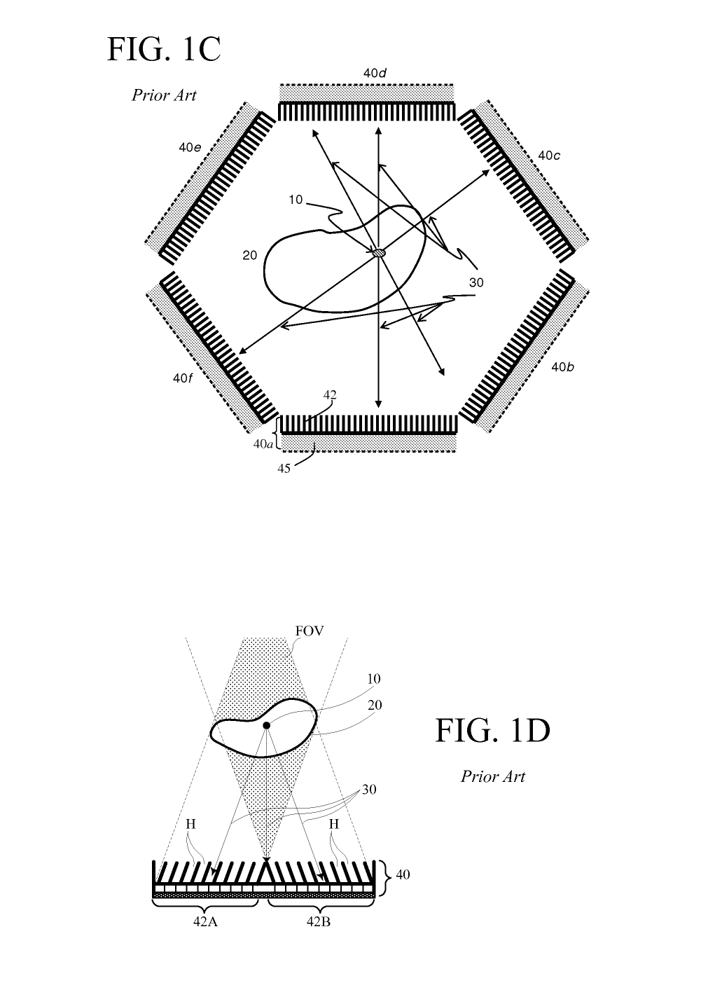

As illustrated in the embodiment of FIGS. 4A and 4B, by altematingly interweaving at least two groups of apertures, the overall size of the detector may be effectively reduced to a size comparable to the size of the object or region of interest. In contrast, the prior art of FIG. 1D requires detector modules of at least twice the size of the object of interest. As a result, it is evident from the foregoing description that at least one embodiment of the interwoven multi-aperture collimator of the present invention addresses the needs of radiation imaging applications where a compact radiation detector may be used very close to, or even in contact with, the object of interest.

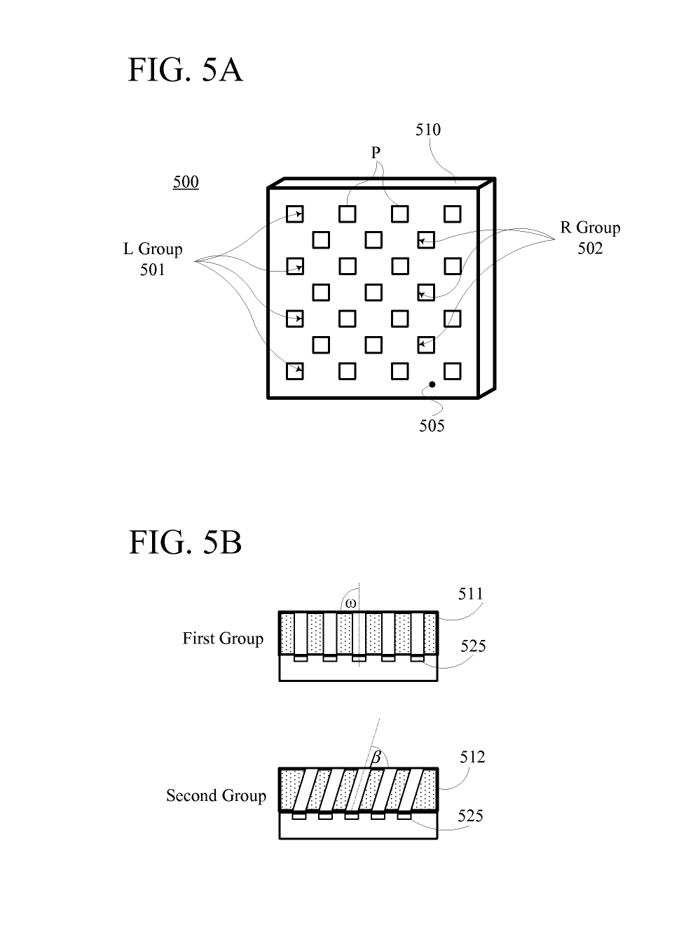

FIGS. 5A and 5B illustrate further embodiments of the present invention, which are based on modifications of the embodiment described in FIG. 2. Elements and structures already described in reference to FIG. 2 are now omitted. FIG. 5A illustrates a multi-aperture collimator 500 having a surface plane 505 in which a plurality of apertures P is arranged in rows offset from each other, and divided into a first group 501 (L Group) and a second group 502 (R Group). The two groups are interwoven in a manner similar to the groups of apertures in the collimator of FIG. 2. However, the apertures P in the embodiment of FIG. 5A are designed such that the geometric cross-section of each aperture is defined by a parallelogram. For example, in the embodiment of FIG. 5A, the geometric cross-section of each aperture may be defined by a rectangle or a square. An aperture of a rectangular or square cross-section may be advantageous in facilitating the alignment of each aperture with the corresponding radiation detecting element or pixel (not shown) to thereby improve detection efficiency. For example, in a multi-aperture collimator 500 designed in a pattern generally mimicking the grid-like arrangement of rows and columns, as well as the cross-sectional shapes, of an array of detector elements, the surface of each radiation detecting element would be optimally exposed to only radiation passing along the desired paths from a given radiation region of interest from an imaged object. Specifically, matching the geometric cross-section of each aperture to the geometrical shape of each detecting element would lead to more efficient radiation detection. The geometrical cross-section of each group of apertures is not limited to the above-described structures. For example, in addition to the above-described, apertures with geometrical cross-sections defined by a hexagon or other polygon, or combinations thereof are considered to be within the scope of the present invention.

FIG. 5B illustrates another modification of the embodiment shown in FIG. 2. In the embodiment of FIG. 5B, the first and second groups of apertures are interwoven similarly to that of the first embodiment. Specifically, the rows of apertures from the first group 511 and those of the second group 512 are alternatingly interwoven with each other. The apertures in the first group 511 are arranged with a first orientation angle ω, which is orthogonal to the surface plane of the collimator, while the apertures in the second group 512 are arranged with a second orientation angle β (e.g., slanted to a predetermined angle) with respect to the surface plane of the collimator. This particular embodiment may be advantageous in obtaining different magnifications from each different imaging view. For example, depending upon the object's distance from the radiation detection device, an image obtained by the first group 511 (orthogonal to the object) may produce an actual size image, while an image obtained by the second group 512 (slanted to a predetermined angle) may be designed to produce an image with a predetermined level of magnification.

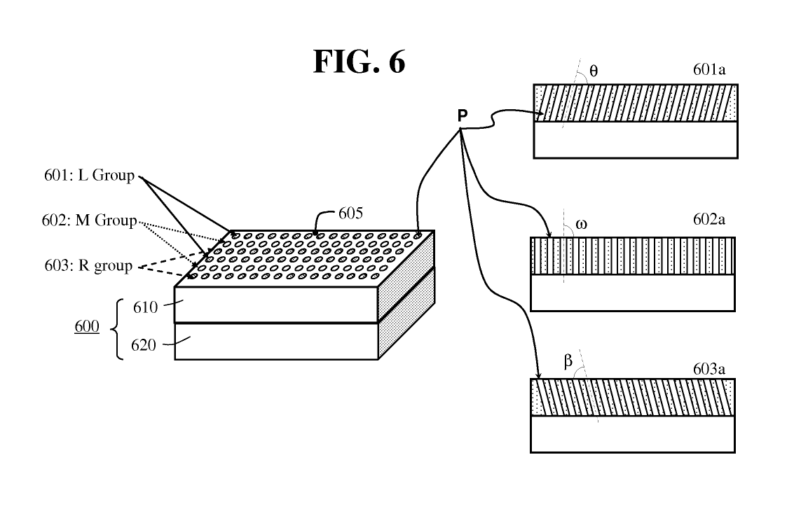

FIG. 6 illustrates a further modification to the embodiment shown in FIG. 2. In accordance with the embodiment of FIG. 6, a radiation detection device 600 includes a multi-aperture collimator 610 and a detector module 620. Multi-aperture collimator 610 has a surface plane 605. A plurality of apertures, e.g., pinholes or parallel holes, is disposed throughout the collimator body. The plurality of apertures is selectively divided into three groups, and each group is interwoven with the others in a manner similar to the embodiment of FIG. 2. The apertures of a first group 601 (L Group), configured to define a left imaging view, are arranged with a first orientation angle θ with respect to the surface plane 605 of the collimator. Respectively, a second group 602 (M Group) and a third group (R Group), configured to define corresponding middle and right imaging views, may have corresponding angles ω and β with respect to the surface plane 605 of the collimator. Cross-sectional views across a row of apertures in the first, second, and third groups are represented by reference numerals 601a, 602a and 603a, respectively.

In the embodiment of FIG. 6, within the first group 601, second group 602, and third group 603 all of the apertures P are parallel. More specifically, within each group, each of the axes of the plurality of apertures P is parallel to all others. This particular embodiment may be advantageous in obtaining further views and/or magnification levels that may be useful in obtaining more accurate image reconstruction while maintaining a compact size in the detector module. For example, first group 601 may be used for imaging at a first predetermined level of magnification, the second group 602 may be utilized for non-magnification imaging, e.g., real size imaging, and the third group 603 may be used for imaging from different angle and at another predetermined level of magnification. In other words, each of the groups may be designed for imaging at a predetermined level of magnification, in accordance with the optimized sensitivity and resolution requirements of a given system.

### II. Examples of Interwoven Multi-Aperture Collimator Applications

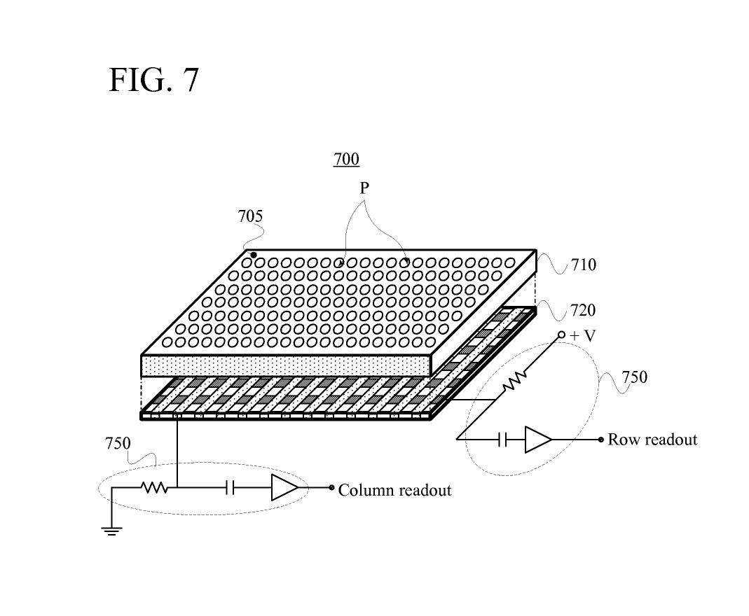

FIG. 7 illustrates one possible configuration of a radiation detection device 700 including an interwoven multi-aperture collimator 710 and a radiation detector module 720 for 3-D imaging applications. The multi-aperture collimator 710 having a surface plane 705 includes a 2-D grid of apertures P. The apertures in the grid may be arranged orthogonally or in a honeycomb-like arrangement as illustrated in FIGS. 3A and 3B, respectively. The grid is divided into at least two groups of apertures that are interwoven and arranged in accordance with any of the above-described embodiments, or equivalents thereof. Detection module 720 may include solid-state detectors or scintillator detectors configured to detect radiation beams incoming from an object of interest (not shown) and transmitted through the interwoven multi-aperture collimator 710.

Scintillator detectors include a sensitive volume of a luminescent material (liquid or solid) that is viewed by a device that detects the gamma ray-induced light emissions (usually a photomultiplier (PMT) or photodiode). The scintillation material may be organic or inorganic. Examples of organic scintillators are anthracene and p-Terphenyl, but it is not limited thereto. Some common inorganic scintillation materials are sodium iodide (NaI), cesium iodide (CsI), zinc sulfide (ZnS), and lithium iodide (LiI), but it is not limited thereto. Bismuth germanate (Bi₄Ge₃O₁₂), commonly referred to BGO, has become very popular in applications with high gamma counting efficiency and/or low neutron sensitivity requirements. In most clinical SPECT systems, thallium-activated sodium iodide, NaI(Tl), is a commonly used scintillator.

Solid-state detectors include semiconductors that provide direct conversion of detected radiation energy into an electronic signal. The gamma ray energy resolution of these detectors is dramatically better than that of scintillation detectors. Solid-state detectors may comprise a crystal, typically having either a rectangular or circular cross-section, with a sensitive thickness selected on the basis of the radiation energy region relevant to the application of interest. Solid-state detectors such as cadmium zinc telluride (CdZnTe or CZT), cadmium manganese telluride (CdMnTe or CMT), Si, Ge, amorphous selenium, among others, have been proposed and are well suited for radiation imaging applications in which the interwoven multi-aperture collimator may be applied.

The detector module 720 of FIG. 7 may be based on an orthogonal strip design. An orthogonal strip detector may be double-sided, as proposed by J. C. Lund et al. in “Miniature Gamma-Ray Camera for Tumor Localization”, issued by Sandia National Laboratories (August 1997) which is incorporated by reference herein in its entirety. Alternatively, the detector module 720 may be based on an array of single detector elements or pixilated detectors.

In the example of FIG. 7, detector module 720 represents one possible configuration of a double-sided orthogonal strip design. In the double-sided orthogonal strip design, rows and columns of parallel electrical contacts (strips) are placed at right angles to each other on opposite sides of a piece of semiconductor wafer. Radiation detection on the detector plane is determined by scoring a coincidence event between a column and a row. More specifically, when radiation beams emitted from an object of interest traverse apertures P of collimator 710, only the radiation beams substantially parallel to the axis of the aperture P arrive at a crossing of a column and a row, to thereby generate a signal. Readout electronics 750 transmit the received signals to processing and analyzing equipment in a known manner.

Using the orthogonal strip design reduces the complexity of the readout electronics considerably. In general, to read out an array of N² detecting elements only requires 2×N channels of readout electronics (750 in FIG. 7), as opposed to N² channels required for an array of N×N individual pixels. The single-sided orthogonal strip detector operates on a charge sharing principle using collecting contacts organized in rows and columns on only one side of the detector, e.g., the anode surface of a semiconductor detector. A single-sided strip detector requires even fewer electronic channels than a double-sided one. For example, whereas double-sided detectors require that electrical contacts be made to the strips on both sides, single-sided (coplanar) ones use collecting contacts arranged only on one side of the detector. Because of the simplicity in design and reduced complexity of the readout electronics, detector modules of orthogonal strip design are considered particularly advantageous to the application of the various embodiments of the interwoven multi-aperture collimator of this invention. However, the applications of the interwoven multi-aperture collimator are not limited thereto.

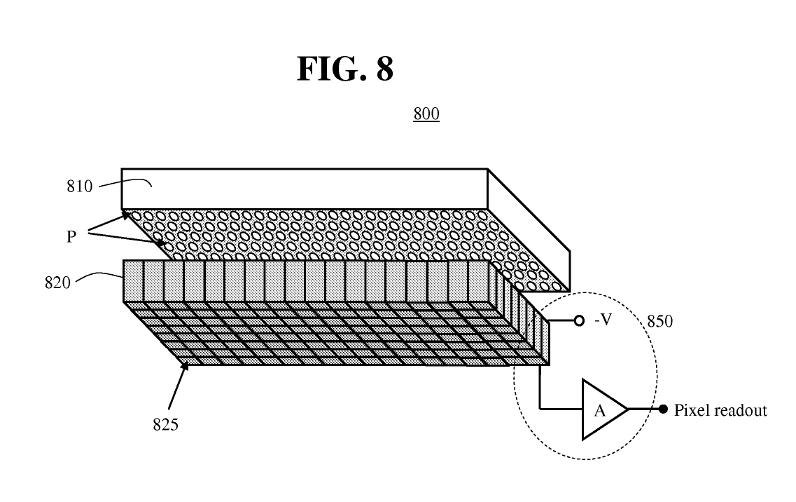

FIG. 8 illustrates another exemplary application of the interwoven multi-aperture collimator. In the embodiment of FIG. 8, a radiation detection device 800 includes an interwoven multi-aperture collimator 810 and a detector module 820. Detector module 820, in this embodiment, includes an array of single detection elements 825. Radiation beams (not shown) substantially parallel to the axis of apertures P traverse collimator 810 and are detected by individual detection elements 825. Here, the single detection element 825 may be based on scintillator plus photon-sensing devices or semiconductor detectors with various configurations including but not limited to planar detector or the so-called Frisch-grid detector design, as proposed by A. E. Bolotnikov et al. in “Optimization of virtual Frisch-grid CdZnTe detector designs for imaging and spectroscopy of gamma rays”, Proc. SPIE, 6706, 670603 (2007), which is incorporated by reference herein in its entirety. Readout electronics 850 transmit the detected signal to processing and analyzing equipment in a known manner.

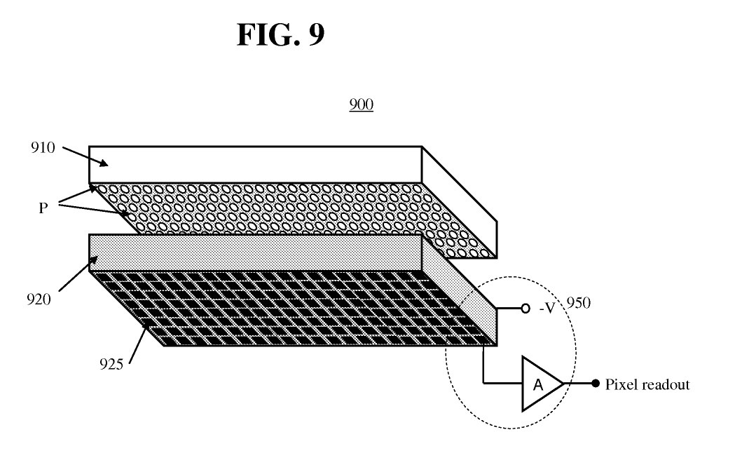

FIG. 9 illustrates a further example of a radiation imaging device 900, including an interwoven multi-aperture collimator 910 and a detector module 920. The interwoven multi-aperture collimator may be designed in accordance with any of the embodiments described in reference to FIGS. 2-6 of the present invention. The detector module 920 includes a pixilated detector with a plurality of sensing electrodes 925, which are arranged in correspondence with the plurality of apertures P of collimator 910. Here, the pixilated detector is a semiconductor detector with a common electrode on one side and an array of sensing electrodes on the other side. Readout electronics 950 transmit the detected signal to processing and analyzing equipment in a manner similar to the examples of FIG. 7 or 8.

All publications and patents mentioned in the above specification are herein incorporated by reference. Various modifications and variations of the described interwoven multi-pinhole collimator will be apparent to those skilled in the art without departing from the scope and spirit of the invention. Although the disclosure has been described in connection with specific preferred embodiments, it should be understood that the invention as claimed should not be unduly limited to such specific embodiments. Indeed, those skilled in the art will recognize, or be able to ascertain using no more than routine experimentation, many equivalents to the specific embodiments of the invention described herein. Such equivalents are intended to be encompassed by the following claims.

1. A collimator, comprising:
a collimator body configured to absorb and collimate radiation beams emitted from a radiation source within a field of view of said collimator, said collimator body having a surface plane disposed closest to said radiation source; and
a plurality of apertures disposed in a two-dimensional grid throughout said collimator body, said plurality of apertures being divided into a plurality of groups that define respectively a plurality of views of an object to be imaged, wherein said groups of apertures are interleaved or interwoven in the two-dimensional grid throughout the collimator body.

2. The collimator of claim 1, wherein the plurality of apertures is divided into a first group and a second group defining respectively a first view and a second view of an object to be imaged, wherein said first group of apertures is formed by interleaving the rows of apertures and said second group of apertures is formed by rows of apertures adjacent to the rows of the first group, and wherein the apertures within said first group have respective longitudinal axes aligned along a first orientation angle with respect to said surface plane, and the apertures within said second group have respective longitudinal axes aligned along a second orientation angle with respect to said surface plane such that the apertures of the first group are interwoven with the apertures of the second group.

3. The collimator of claim 2, wherein the plurality of apertures is further divided into a third group further defining respectively a third view of the object to be imaged, wherein said third group of apertures is formed by further interleaving rows of the apertures located between the rows of apertures of the first and second groups, and
wherein the apertures within said third group have respective longitudinal axes aligned along a third orientation angle with respect to said surface plane such that the apertures of the third group are interwoven with the apertures of the first and second groups.

4. The collimator of claim 2, wherein the plurality of apertures is further divided into an additional group(s) further defining respectively additional views of the object to be imaged, wherein said additional group of apertures is formed by further interleaving rows of the apertures located between the rows of apertures of the earlier groups, and
wherein the apertures within said additional group have respective longitudinal axes aligned along an additional orientation angle with respect to said surface plane such that the apertures of the additional group are interwoven with the apertures of the earlier groups.

5. The collimator of claim 2, wherein the apertures in the first group are perpendicular to the surface plane and the apertures in the second group are slanted to a predetermined angle with respect to the surface plane of said collimator body.

6. The collimator of claim 3, wherein the apertures of the first group are slanted to a first predetermined angle with respect to the surface plane, the apertures of the second group are slanted to a second predetermined angle with respect to the surface plane, and the apertures of the third group are perpendicular to the surface plane of said collimator body.

7. The collimator of claim 2, wherein the apertures of the first group are slanted to a first angle with respect to the surface plane, and the apertures of the second group are slanted to a second angle with respect to the surface plane of said collimator body.

8. The collimator of claim 1, wherein the plurality of apertures is disposed in said two-dimensional grid such that rows and columns of the grid are perpendicular to each other.

9. The collimator of claim 1, wherein the plurality of apertures is disposed in said two-dimensional grid such that successive rows of the grid are offset from each other such that the plurality of apertures forms a honeycomb-like structure on the surface plane of the collimator body.

10. The collimator of claim 1, wherein the apertures are pinholes.

11. The collimator of claim 1, wherein the apertures are parallel holes.

12. The collimator of claim 1, wherein the plurality of apertures is formed by (a) machining holes in a solid plate of radiation-absorbing material, (b) laterally arranging septa of radiation absorbing material so as to form radiation-guiding conduits or channels, or (c) vertically stacking multiple layers of radiation-absorbing materials with each layer having a predetermined aperture cross-section.

13. The collimator of claim 1, wherein the apertures have a geometric cross-section defined by at least one of a circle, a parallelogram, a hexagon, a polygon, and combinations thereof.

14. The collimator of claim 2, wherein within the first group of apertures each aperture is parallel to all others and within the second group of apertures each aperture is parallel to all others.

15. The collimator of claim 1, wherein the collimator is fabricated of a radiation-absorbing material.

16. The collimator of claim 15, wherein the radiation-absorbing material has a high density and moderate-to-high atomic mass.

17. The collimator of claim 14, wherein the radiation-absorbing material is selected based on the type of incident radiation and the energy level of the radiation when it strikes the surface plane of the collimator.

18. The collimator of claim 17, wherein the incident radiation is emitted by ¹²⁵I, ¹¹¹In, ^{99m}Tc, ¹³¹I, ¹⁰³Pd or a combination thereof.

19. The collimator of claim 17, wherein the incident radiation is emitted by an external radiation source or device that generates X-rays.

20. The collimator of claim 15, wherein the radiation-absorbing material is selected from the group consisting of lead (Pb), tungsten (W), gold (Au), molybdenum (Mo), and copper (Cu).

21. A radiation imaging device configured to perform three-dimensional radiation imaging, the radiation imaging device comprising: an interwoven multi-aperture collimator as set forth in claim 1; and a radiation detection module, wherein the radiation detection module includes at least one of a pixilated detector, an orthogonal strip detector, and an array of single individual detectors.

22. The radiation imaging device of claim 21, wherein the radiation detector includes scintillation detectors and solid-state detectors.

23. A method of radiation imaging comprising
a) defining a predetermined target location in an object of interest;
b) positioning an interwoven multi-aperture collimator near the target location;
c) collimating radiation from the target location by an interwoven multi-aperture collimator in the field of view of said interwoven multi-aperture collimator into at least two views of the target location, wherein, the view of the target location is defined by a plurality of apertures disposed in a two-dimensional grid throughout a collimator body;
d) detecting radiation that passes through the interwoven multi-aperture collimator by a radiation detection module; and
e) processing the information recorded by the radiation detection module to produce a desired image based on the defined angle of the apertures in the interwoven multi-aperture collimator.

24. The method of radiation imaging according to claim 23, comprising collimating radiation from the target location by an interwoven multi-aperture collimator in the field of view of said interwoven multi-aperture collimator into a first and a second view of the target location, defined, respectively, by a first group and a second group of apertures disposed throughout the collimator body,
wherein said first group of apertures is formed by interleaving the rows of apertures and said second group of apertures is formed by rows of apertures adjacent to the rows of the first group, and wherein the apertures within said first group have respective longitudinal axes aligned along a first orientation angle with respect to said surface plane, and the apertures within said second group have respective longitudinal axes aligned along a second orientation angle with respect to said surface plane such that the apertures of the first group are interwoven with the apertures of the second group.

25. The method of radiation imaging according to claim 24, further comprising collimating the radiation emitted from the target location by the interwoven multi-aperture collimator in the field of view of said interwoven multi-aperture collimator into a third view of the target location,
wherein the plurality of apertures is further divided into a third group, formed by further interleaving rows of the apertures located between the rows of apertures of the first and second groups, and said apertures within the third group have respective longitudinal axes aligned along a third orientation angle with respect to said surface plane such that the apertures of the third group are interwoven with the apertures of the first and second groups.

26. The method of radiation imaging according to claim 25, further comprising collimating the radiation emitted from the target location by the interwoven multi-aperture collimator in the field of view of said interwoven multi-aperture collimator into an additional view(s) of the target location,
wherein the plurality of apertures is further divided into an additional group(s) formed by further interleaving rows of the apertures located between the rows of apertures of the earlier groups, and wherein the apertures within said additional group have respective longitudinal axes aligned along an additional orientation angle with respect to said surface plane such that the apertures of the additional group are interwoven with the apertures of the earlier groups.

27. The method of radiation imaging according to claim 24, wherein the apertures in the first group are perpendicular to a surface plane and the apertures in the second group are slanted to a predetermined angle with respect to the surface plane of said collimator body.

28. The method of radiation imaging according to claim 25, wherein the apertures of the first group are slanted to a first predetermined angle with respect to the surface plane, the apertures of the second group are slanted to a second predetermined angle with respect to the surface plane, and the apertures of the third group are perpendicular to the surface plane of said collimator body.

29. The method of radiation imaging according to claim 24, wherein the apertures of the first group are slanted to a first angle with respect to the surface plane, and the apertures of the second group are slanted to a second angle with respect to the surface plane of said collimator body.

30. The method of radiation imaging according to claim 23, wherein the plurality of apertures is disposed in said two-dimensional grid such that rows and columns of the grid are perpendicular to each other.

31. The method of radiation imaging according to claim 23, wherein the plurality of apertures is disposed in said two-dimensional grid such that successive rows of the grid are offset from each other such that the plurality of apertures forms a honeycomb-like structure on the surface plane of the collimator body.

32. The method of radiation imaging according to claim 23, wherein the apertures are pinholes, parallel holes or a combination thereof.

33. The method of radiation imaging according to claim 21, wherein the apertures have a geometric cross-section defined by at least one of a circle, a parallelogram, a hexagon, a polygon, or combinations thereof.

34. The method of medical radiation imaging according to claim 24, wherein within the first group of apertures each aperture is parallel to all others and within the second group of apertures each aperture is parallel to all others.

35. The method of radiation imaging according to claim 23, wherein the collimator is fabricated of a radiation-absorbing material.

36. The method of radiation imaging according to claim 35, wherein the radiation-absorbing material is a high-Z material that has high density and/or high atomic mass.

37. The method of radiation imaging according to claim 35, wherein the radiation-absorbing material is selected based on the type of incident radiation and the energy level of the radiation when it strikes the surface plane of the collimator.

38. The method of radiation imaging according to claim 37, wherein the incident radiation is emitted by ¹²⁵I, ¹¹¹In, ^{99m}Tc, ¹³¹I, ¹⁰³Pd, or a combination thereof.

39. The method of radiation imaging according to claim 37, wherein the incident radiation is emitted by an external radiation source or device that generates X-rays.

40. The method of radiation imaging according to claim 36, wherein the radiation-absorbing material is selected from the group consisting of lead (Pb), tungsten (W), gold (Au), molybdenum (Mo), and copper (Cu).

41. The method of radiation imaging according to claim 23, wherein the radiation detection module is selected from at least one of a pixilated detector, an orthogonal strip detector, and an array of single individual detectors.

42. The method of radiation imaging according to claim 41, wherein the radiation detector includes scintillation detectors and solid-state detectors.

43. The method of radiation imaging according to claim 23, wherein the object of interest in a portion of a human body and the radiation is emitted by a radiotracer concentrated in the target location.

44. The method of radiation imaging according to claim
23, wherein the object of interest is inanimate body and the radiation passes
through the target location from an external radiation source.
